(19) United States
(12) Patent Application Publication
(10) Pub. No.: US 2024/0131538 A1
(43) Pub. Date: Apr. 25, 2024

(54) ANNULAR AIRFLOW REGULATING APPARATUS AND METHOD

(71) Applicant: Industrial Technology Research Institute, Hsinchu (TW)

(72) Inventors: CHEN-CHUNG DU, Hsinchu City (TW); Ming-Jyh Chang, Hsinchu City (TW); Chang-Yi Chen, Hsinchu City (TW); Ming-Hau Tsai, Keelung City (TW); Ko-Chieh chao, Taipei City (TW); Yi-Wei Lin, Taichung City (TW)

(21) Appl. No.: 18/063,428

(22) Filed: Dec. 8, 2022

(30) Foreign Application Priority Data
Oct. 24, 2022 (TW) 111140428

(51) Int. Cl. B05B 7/04

(52) U.S. Cl. CPC B05B 7/0441

(57) ABSTRACT

An annular airflow regulating apparatus includes a cup-shaped element and an adjustment element. The cup-shaped element has a bowl and a bottom, integrated to form a first chamber. The bottom has a tapered channel parallel to an axis and penetrating through the bottom. A ring-shaped groove is disposed between the tapered channel and the bottom. The ring-shaped groove has an annular plane perpendicular to the axis. The adjustment element, having a tapered portion and second holes, is movably disposed in the cup-shaped element. The tapered portion protrudes into the tapered channel A tapered annular gap is formed between the tapered portion and the tapered channel. When the adjustment element is moved with respect to the cup-shaped element, a width of the tapered annular gap is varied, and thereupon a flow rate and velocity of the process gas would be varied accordingly.

### CROSS REFERENCE TO RELATED APPLICATION

This application claims the benefits of Taiwan application Serial No. 111140428, filed on Oct. 25, 2022, the disclosures of which are incorporated by references herein in its entirety.

### TECHNICAL FIELD

The present disclosure relates in general to a process technology, and more particularly to an annular airflow regulating apparatus and method including an adjustable annular rectifier structure.

### BACKGROUND

As far as the jet printing process is concerned, the processing method is mainly to utilize a nozzle to mix process materials and a gas to form an aerosol, and then the aerosol is sprayed to a workpiece. Due to the fixed annular gap limitation of the conventional nozzle, the diameter range of the nozzle is generally limited. Thus, while in meeting different processing tasks, required gas spray rates are usually different. Hence, it is necessary to replace an appropriate nozzle to maintain a steady flow output of the atomized process material.

However, in order to replace the nozzle, the processing steps shall need to be temporarily interrupted, and definitely the related elements around the nozzle shall be re-aligned after the nozzle replacement. Inevitably, in addition to costs in labors and time, the processing quality might be degraded due to inaccurate or inappropriate alignment.

Accordingly, under the premise of increasing the amount of gas spray, how to develop an annular airflow regulating apparatus and method that can maintain a steady flow field for providing atomized materials, can perform continuous processing without an interruption step for nozzle replacement and repeated realignment, but can still meet different process requirements for various processing tasks, is definitely an urgent problem to be solved by those in the relevant technical field.

### SUMMARY

In one embodiment of this disclosure, an annular airflow regulating apparatus includes:
a cup-shaped element, having a bowl and a bottom, the bowl and the bottom being integrated to form a first chamber, the bowl having radially a first hole, the bottom being furnished with a tapered channel parallel to an axis and penetrating through the bottom, a ring-shaped groove being disposed at a connecting portion of the tapered channel and the bottom by surrounding the axis, the ring-shaped groove having an annular plane perpendicular to the axis; and
an adjustment element, having a tapered portion and a plurality of second holes, being movably disposed in the cup-shaped element, the tapered portion protruding into the tapered channel, a tapered annular gap being formed between an outer surface of the tapered portion and the tapered channel; wherein, when the adjustment element is moved with respect to the cup-shaped element, a width of the tapered annular gap is varied.

In another embodiment of this disclosure, an annular airflow regulating method, utilizing the annular airflow regulating apparatus of this disclosure, includes the steps of:
disposing an annular airflow regulating apparatus, including:
a cup-shaped element, having a bowl and a bottom, the bowl and the bottom being integrated to form a first chamber, the bowl having radially a first hole, the bottom being furnished with a tapered channel parallel to an axis and penetrating through the bottom, a ring-shaped groove being disposed at a connecting portion of the tapered channel and the bottom by surrounding the axis, the ring-shaped groove having an annular plane perpendicular to the axis; and
an adjustment element, having a tapered portion and a plurality of second holes, being movably disposed in the cup-shaped element, the tapered portion protruding into the tapered channel, a tapered annular gap being formed between an outer surface of the tapered portion and the tapered channel; wherein, when the adjustment element is moved with respect to the cup-shaped element, a width of the tapered annular gap is varied;
inputting a process gas into the cup-shaped element from the first hole;
flowing the process gas into the ring-shaped groove via the plurality of second holes to further hit the annular plane;
deflecting the process gas by a 90° to enter the tapered annular gap; and
controlling the adjustment element to move with respect to the cup-shaped element, so as to vary the width of the tapered annular gap, and thus to vary a flow rate and a flow velocity of the process gas.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic perspective view of an embodiment of the annular airflow regulating apparatus in accordance with this disclosure;

FIG. 2 is a schematic axial cross-sectional view of FIG. 1;

FIG. 3 is a schematic plane view of FIG. 2;

FIG. 4 is another view of FIG. 3, where the cup-shaped element and the adjustment element are separated;

FIG. 5 is a schematic enlarged view of area A of FIG. 3;

FIG. 6 is another state of FIG. 4, with a smaller gap between the cup-shaped element and the adjustment element;

FIG. 6A is a schematic enlarged view of area B of FIG. 6; and

FIG. 7 is a schematic flowchart of an embodiment of the annular airflow regulating method in accordance with this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

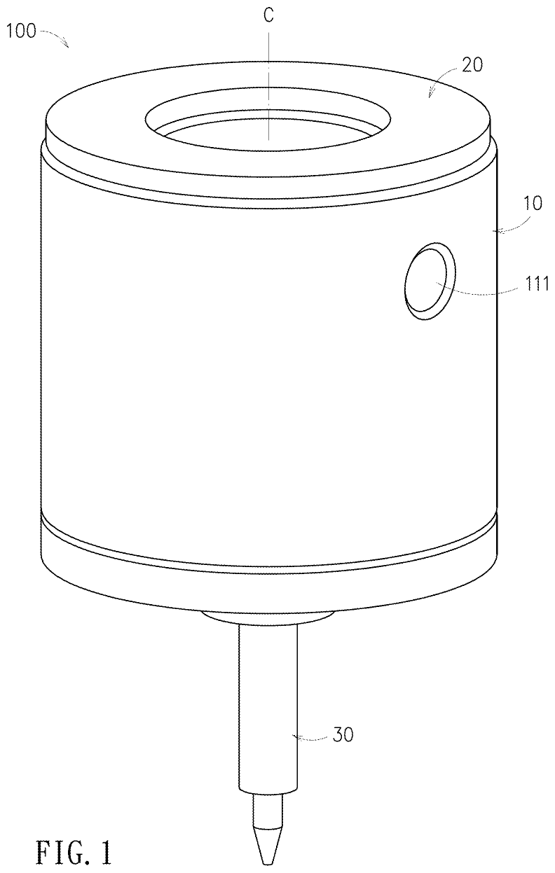

Referring to FIG. 1, in this embodiment, the annular airflow regulating apparatus 100 includes a cup-shaped element 10 and an adjustment element 20.

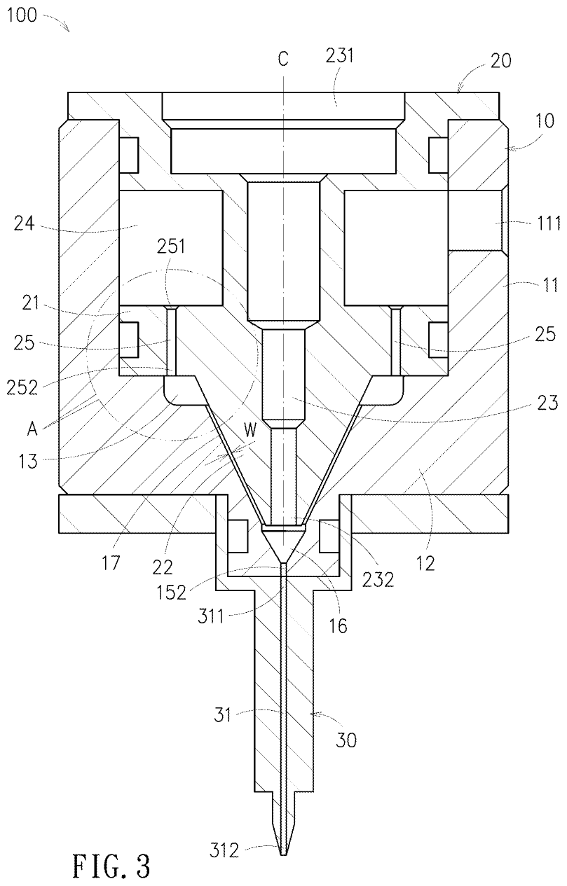

Referring to FIG. 1 to FIG. 4, the cup-shaped element 10 includes a bowl 11, a bottom 12 and a ring-shaped groove 13.

In this embodiment, the bowl 11, shaped to be a ring having an axis C, is furnished with a first hole 111 having a center line perpendicular to the axis C, and the first hole 111 is a through hole penetrating a wall of the bowl 11.

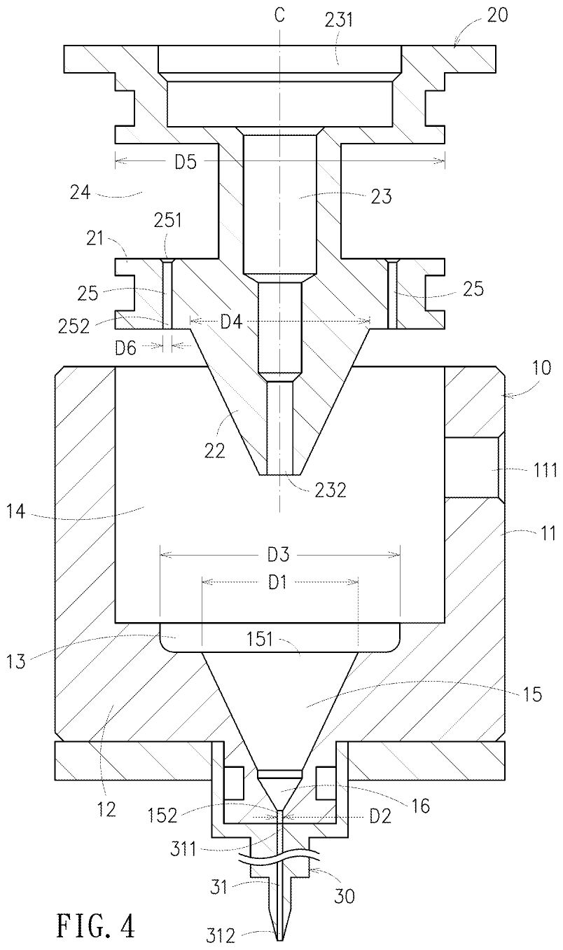

Referring to FIG. 4, the bottom 12 is disposed at an axial end of the bowl 11 (i.e., the bottom end of the bowl 11 in the figure), and the bottom 12 integrates the bowl 11 to form a first chamber 14.

The bottom 12 is furnished with a tapered channel 15 parallel to the axis C and penetrating through the bottom 12.

The tapered channel 15 has oppositely a first inlet end 151 and a first outlet end 152. An inner diameter D1 of the first inlet end 151 is greater than an inner diameter D2 of the first outlet end 152, in which the first inlet end 151 is disposed by facing the first chamber 14.

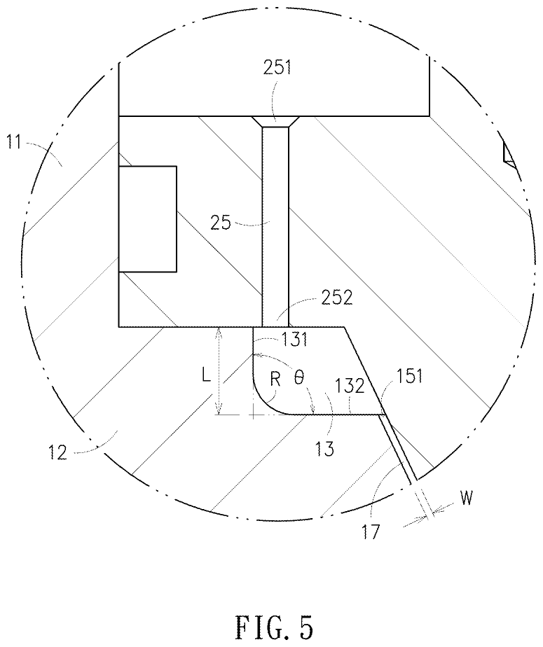

Referring to FIG. 4 and FIG. 5, the ring-shaped groove 13 is disposed at a connecting portion of the first inlet end 151 and the bottom 12 by surrounding the axis C. An inner diameter D3 of the ring-shaped groove 13 is greater than the inner diameter D1 of the first inlet end 151.

The ring-shaped groove 13 has an annular wall 131 and an annular plane 132. The annular wall 131 stands parallel to the axis C, and the annular plane 132 is perpendicular to the axis C.

Referring to FIG. 5, the annular wall 131 and the annular plane 132 are disposed by having an angle θ of about 90°, but not limited thereto. In this embodiment, the angle θ is within 90°±5°. Further, the annular plane 132 is spaced to the gas-outlet end 252 by a distance L, the annular wall 131 and the annular plane 132 are smoothly connected by an arc surface having a radian R, and the radian R is related to the distance L by a relationship of R=L/2. Practically, the determination of the angle θ and the radian R is mainly up to design demands.

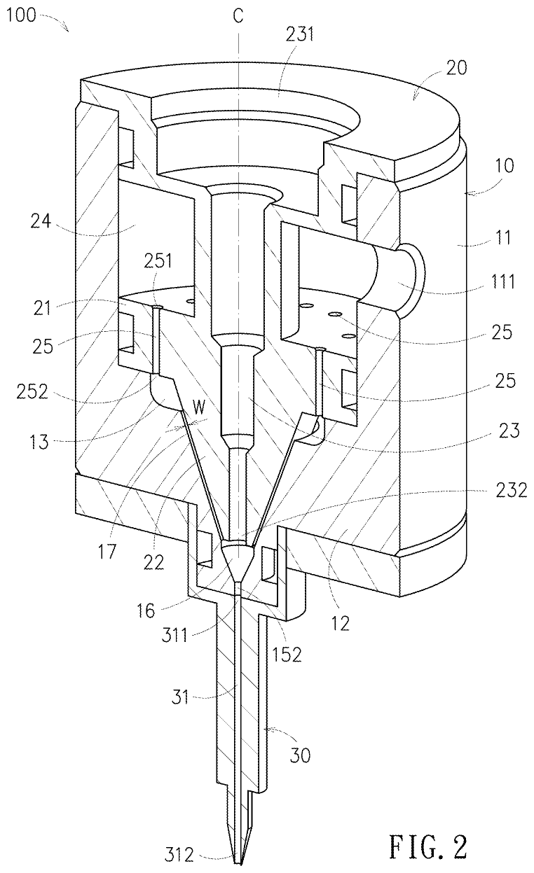

Referring to FIG. 2 to FIG. 4, the adjustment element 20 includes a main body 21, a tapered portion 22, a second channel 23, a second chamber 24 and a plurality of second holes 25. In this embodiment, the second chamber 24 is annular shaped and connected spatially with the first hole 111 of the cup-shaped element 10.

The main body 21 is disposed in the first chamber 13 by being parallel to the axis C.

The tapered portion 22 is disposed at an end of the main body 21 by being parallel to the axis C; i.e., disposed to a bottom of the main body 21 as shown in the figure. The tapered portion 22 is protruded down from the main body 21 in a taper manner and by being parallel to the axis C. As shown in FIG. 4, an outer diameter D4 of the connecting portion of the tapered portion 22 and the main body 21 is less than an outer diameter D5 of the main body 21. In addition, the tapered portion 22 and the tapered channel 15 have the same taper.

Referring to FIG. 2 to FIG. 4, the second channel 23 is extended by being parallel to the axis C, and by penetrating through both the main body 21 and the tapered portion 22. Two opposite ends of the second channel 23 are formed to be a second inlet end 231 and a second outlet end 232.

The second chamber 24 is disposed to surround the second channel 23 of the main body 21 by being parallel to the axis C.

Referring to FIG. 4 and FIG. 5, the plurality of second holes 25 are separately disposed at the main body 21 by being parallel to the axis C and extending from the second chamber 24 to a bottom surface of the main body 21. Each of the second holes has oppositely a gas-inlet end 251 and a gas-outlet end 252. As shown in FIG. 4, a diameter D6 of the second hole 25 is ranged within 0.5˜2 mm. A projection of the second hole 25 is located within the annular plane 132. As shown in FIG. 4, the annular plane 132 and the gas-outlet end 252 is separated by a distance L ranging within 1˜9 mm.

Referring to FIG. 2 to FIG. 5, the adjustment element 20 is movably disposed in the cup-shaped element 10 by being parallel to the axis C. When the tapered portion 22 is protruded to dispose into the tapered channel 15, a tapered area 16 is formed between the second outlet end 232 and the tapered channel 15, and a tapered annular gap 17 is formed between an outer surface of the tapered portion 22 and the tapered channel 15. Since the tapered portion 22 and the tapered channel 15 are structured to have the same taper, thus a width W of the tapered annular gap 17 is uniform. However, referring to FIG. 5, the width W of the tapered annular gap 17 would be slightly varied with the distance L between the annular plane 132 and the gas-outlet end 252.

Referring to FIG. 2 to FIG. 4, the second channel 23 and the tapered channel 15 are connected spatially, each of the second holes 25 is spatially connected between the ring-shaped groove 13 and the second chamber 24, and the second chamber 24 is further connected spatially with the first hole 111.

Referring to FIG. 1 to FIG. 4, the first outlet end 152 of the cup-shaped element 10 is furnished with a nozzle 30. The nozzle 30 has thereinside a third channel 31 extending to both opposite ends of the nozzle 30 to form a third inlet end 311 and a third outlet end 312, respectively. The tapered channel 15, the second channel 23 and the third channel 31 are co-axially connected.

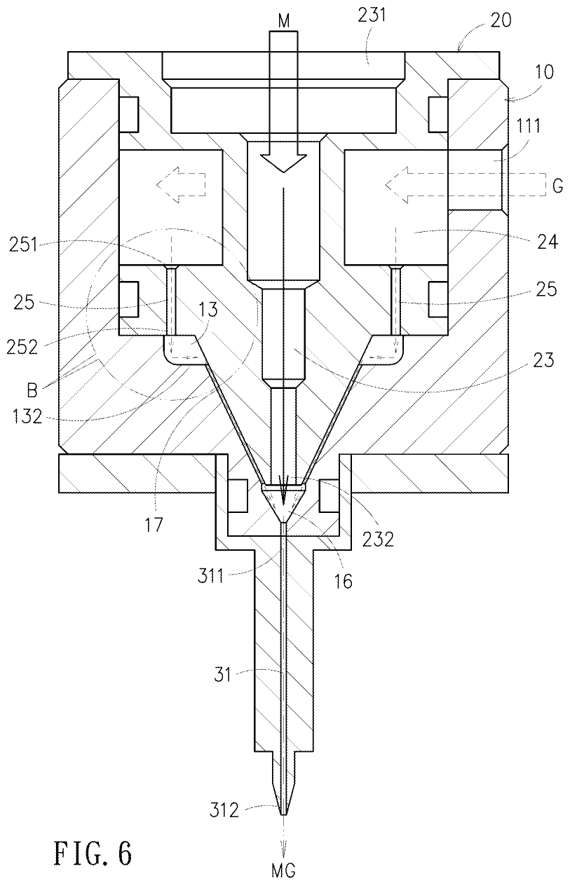

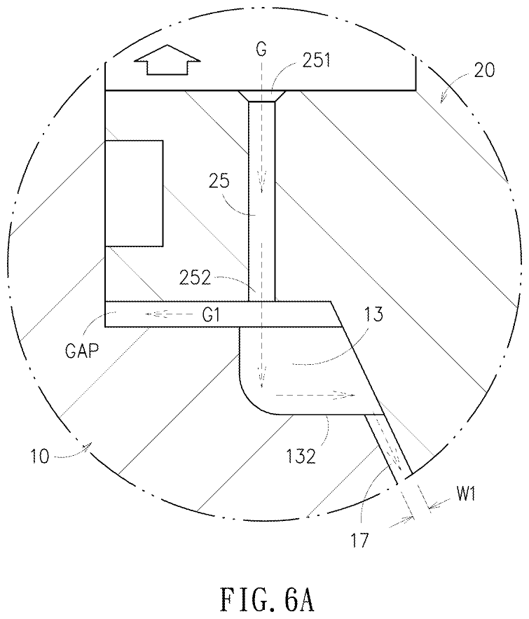

Referring to FIG. 6, in one exemplary example, after a process material M enters the second channel 23 via the second inlet end 231, the process material M would be then flowed into the tapered area 16 via the second outlet end 232.

On the other hand, a process gas G would enter the second chamber 24 via the first hole 111, and then be flowed to the second holes 25 via the gas-inlet end 251, and further to the ring-shaped groove 13 via the gas-outlet end 252 for hitting the annular plane 132. After hitting the annular plane 132, the flow of the process gas G would be deflected by 90° to enter the tapered annular gap 17, and then the tapered area 16.

The process material M and the process gas G would be mixed into a process aerosol MG in the tapered area 16. The process aerosol MG enters the third channel 31 from the tapered area 16 via the third inlet end 311, and then be sprayed out through the third outlet end 312 to a workpiece (not shown in the figure) for appropriate processing.

Referring to FIG. 6 and FIG. 6A, since the adjustment element 20 of this disclosure is movably disposed in the cup-shaped element 10, thus, when the adjustment element 20 is controlled to move in parallel to the axis C, the original width W of the tapered annular gap 17 would vary to another width W1. Thereupon, flow rate and flow velocity of the process gas G can be adjusted, and so an amount of the process aerosol MG out sprayed from the nozzle 30.

It shall be explained that, referring to FIG. 6A, when the adjustment element 20 is moved upward, a gap GAP between a top of the ring-shaped groove 13 and the gas-outlet end 252 would be generated. In one embodiment, when the process gas G is flowed out from the gas-outlet end 252, a tiny amount of the process gas G1 may be leaked into the gap GAP. However, such a leakage of the process gas G1 can be neglected, due to being too small to compare with the process gas G flowed to the ring-shaped groove 13. In this embodiment, after the process gas G1 fills up the gap GAP, no more gas can then enter the gap GAP, and thus the effect of the process gas G1 in the gap GAP on the processing wouldn't be taken into consideration.

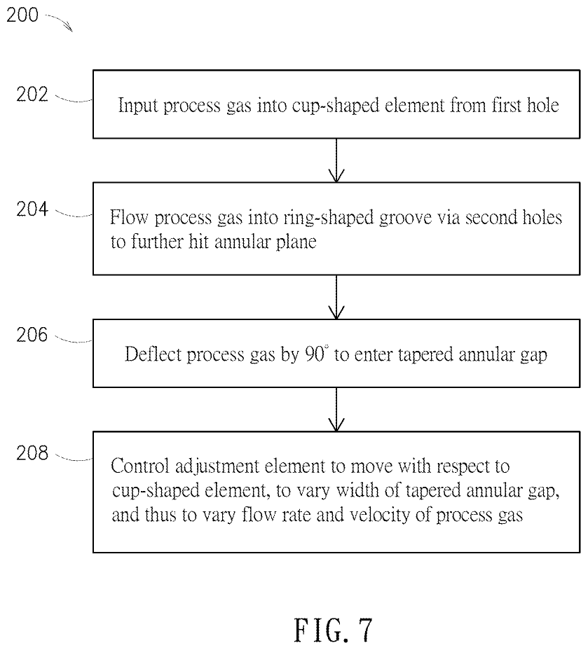

Referring to FIG. 7, by utilizing the aforesaid annular airflow regulating apparatus 100, an annular airflow regulating method 200 can be performed by including the following steps. Please refer to FIG. 6 and FIG. 6A as well.

Step 202: Input the process gas G from the first hole 111 into the cup-shaped element 10.

Step 204: The process gas G is flowed to the second holes 25 via the second chamber 24, then to the ring-shaped groove 13, and hits the annular plane 132 thereafter.

Step 206: The process gas G is deflected and then enters the tapered annular gap 17.

Step 208: Control the adjustment element 20 to move with respect to the cup-shaped element 10, so as to change the width W1 of the tapered annular gap 17, and thus to vary the flow rate and flow velocity of the process gas G.

To sum up, in the annular airflow regulating apparatus and method provided by the present disclosure, the adjustable annular rectifier structure (the adjustment element) is applied to replace the conventional fixed-gap annular rectifier structure. The adjustable element of this disclosure introduces the tapered annular gap that can be adjusted axially and continuously to generate much wider and stabler sheath gas zone for processing to resolve the conventional problem in limiting the nozzle size of gas spray caused by the fixed-gap annular rectifier structure. Under the premise of increasing the amount of gas spray, a steady flow field for providing atomized materials can be still maintained, the step of replacing the nozzle can be eliminated, various processing tasks with different sizes can be continuously performed, interruption amid processing and repeated realignment can be avoided.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An annular airflow regulating apparatus, comprising:
a cup-shaped element, having a bowl and a bottom, the bowl and the bottom being integrated to form a first chamber, the bowl having radially a first hole, the bottom being furnished with a tapered channel parallel to an axis and penetrating through the bottom, a ring-shaped groove being disposed at a connecting portion of the tapered channel and the bottom by surrounding the axis, the ring-shaped groove having an annular plane perpendicular to the axis; and
an adjustment element, having a tapered portion and a plurality of second holes, being movably disposed in the cup-shaped element, the tapered portion protruding into the tapered channel, a tapered annular gap being formed between an outer surface of the tapered portion and the tapered channel; wherein, when the adjustment element is moved with respect to the cup-shaped element, a width of the tapered annular gap is varied.

2. The annular airflow regulating apparatus of claim 1, wherein the bowl is furnished with the first hole perpendicular to the axis and penetrating through the bowl, the first chamber is formed between an axial end of the bottom disposed in the bowl and the bowl, the tapered channel has a first inlet end and a first outlet end, an inner diameter of the first inlet end is greater than another inner diameter of the first outlet end, the first inlet end faces the first chamber, and the ring-shaped groove disposed at the connecting portion of the first inlet end and the bottom by surrounding the axis has an inner diameter greater than another inner diameter of the first inlet end.

3. The annular airflow regulating apparatus of claim 2, wherein the adjustment element includes:
a main body, disposed in the first chamber by being parallel to the axis, the tapered portion being disposed at an end of the main body by being parallel to the axis, the tapered portion protruding from the main body in a taper manner and by being parallel to the axis, an outer diameter of a connecting portion between the tapered portion and the main body being less than another outer diameter of the main body;
a second channel, extended by being parallel to the axis and by penetrating through the main body and the tapered portion, two opposite ends of the second channel being formed to be a second inlet end and a second outlet end, a tapered area being formed between the second outlet end and the tapered channel; and
a second chamber, disposed to surround the second channel of the main body by being parallel to the axis, a plurality of second holes being disposed between the second chamber and a bottom of the main body by being parallel to the axis, each of the plurality of second holes having oppositely a gas-inlet end and a gas-outlet end;
wherein a process material enters the second channel via the second inlet end, and then flows out of the second outlet end to the tapered area;
wherein a process gas enters the second chamber from the first hole, then enters the plurality of second holes from the gas-inlet end and further enters the ring-shaped groove from the gas-outlet end for hitting the annular plane, and the process gas after hitting the annular plane is deflected by 90° to enter the tapered annular gap and then the tapered area.

4. The annular airflow regulating apparatus of claim 3, wherein the annular plane and the gas-outlet end are separated by a distance ranging 1˜9 mm.

5. The annular airflow regulating apparatus of claim 3, wherein the first outlet end of the cup-shaped element is furnished with a nozzle, the nozzle having thereinside a third channel extending to both opposite ends of the nozzle to form a third inlet end and a third outlet end, respectively, the tapered channel, and the second channel and the third channel are co-axially connected; wherein a process aerosol enters the third channel from the tapered area via the third inlet end, and then is sprayed out through the third outlet end; wherein, when the adjustment element is displaced in parallel to the axis, a width of the tapered annular gap is varied as well, and thus a flow rate and a flow velocity of the process gas and an amount of the process aerosol sprayed out from the nozzle are varied accordingly.

6. The annular airflow regulating apparatus of claim 1, wherein each of the plurality of second holes has a projection disposed within the annular plane.

7. The annular airflow regulating apparatus of claim 1, wherein the tapered portion and the tapered channel have the same taper, and the width of the tapered annular gap is uniform.

8. The annular airflow regulating apparatus of claim 1, wherein the ring-shaped groove has an annular wall, an angle is formed between the annular wall and the annular plane, and the angle is within 90°±5°.

9. The annular airflow regulating apparatus of claim 8, wherein the annular plane is spaced to the gas-outlet end of any of the plurality of second holes by a distance L, a connecting portion of the annular wall and the annular plane has a radian R, and R=L/2.

10. The annular airflow regulating apparatus of claim 1, wherein the width of the tapered annular gap is varied with a distance between the annular plane and the gas-outlet end of any of the plurality of second holes.

11. The annular airflow regulating apparatus of claim 1, wherein each of the plurality of second holes has a diameter ranging 0.5˜2 mm.

12. An annular airflow regulating method, comprising the steps of:
disposing an annular airflow regulating apparatus, including:
a cup-shaped element, having a bowl and a bottom, the bowl and the bottom being integrated to form a first chamber, the bowl having radially a first hole, the bottom being furnished with a tapered channel parallel to an axis and penetrating through the bottom, a ring-shaped groove being disposed at a connecting portion of the tapered channel and the bottom by surrounding the axis, the ring-shaped groove having an annular plane perpendicular to the axis; and
an adjustment element, having a tapered portion and a plurality of second holes, being movably disposed in the cup-shaped element, the tapered portion protruding into the tapered channel, a tapered annular gap being formed between an outer surface of the tapered portion and the tapered channel; wherein, when the adjustment element is moved with respect to the cup-shaped element, a width of the tapered annular gap is varied;
inputting a process gas into the cup-shaped element from the first hole;
flowing the process gas into the ring-shaped groove via the plurality of second holes to further hit the annular plane;
deflecting the process gas by a 90° to enter the tapered annular gap; and
controlling the adjustment element to move with respect to the cup-shaped element, so as to vary the width of the tapered annular gap, and thus to vary a flow rate and a flow velocity of the process gas.

13. The annular airflow regulating method of claim 12, wherein the bowl is furnished with the first hole perpendicular to the axis and penetrating through the bowl, the first chamber is formed between an axial end of the bottom disposed in the bowl and the bowl, the tapered channel has a first inlet end and a first outlet end, an inner diameter of the first inlet end is greater than another inner diameter of the first outlet end, the first inlet end faces the first chamber, and the ring-shaped groove disposed at the connecting portion of the first inlet end and the bottom by surrounding the axis has an inner diameter greater than another inner diameter of the first inlet end.

14. The annular airflow regulating method of claim 13, wherein the adjustment element includes:
a main body, disposed in the first chamber by being parallel to the axis, the tapered portion being disposed at an end of the main body by being parallel to the axis, the tapered portion protruding from the main body in a taper manner and by being parallel to the axis, an outer diameter of a connecting portion between the tapered portion and the main body being less than another outer diameter of the main body;
a second channel, extended by being parallel to the axis and by penetrating through the main body and the tapered portion, two opposite ends of the second channel being formed to be a second inlet end and a second outlet end, a tapered area being formed between the second outlet end and the tapered channel; and
a second chamber, disposed to surround the second channel of the main body by being parallel to the axis, a plurality of second holes being disposed between the second chamber and a bottom of the main body by being parallel to the axis, each of the plurality of second holes having oppositely a gas-inlet end and a gas-outlet end;
wherein a process material enters the second channel via the second inlet end, and then flows out of the second outlet end to the tapered area;
wherein a process gas enters the second chamber from the first hole, then enters the plurality of second holes from the gas-inlet end and further enters the ring-shaped groove from the gas-outlet end for hitting the annular plane, and the process gas after hitting the annular plane is deflected by 90° to enter the tapered annular gap and then the tapered area.

15. The annular airflow regulating method of claim 14, wherein the annular plane and the gas-outlet end are separated by a distance ranging 1˜9 mm.

16. The annular airflow regulating method of claim 14, wherein the first outlet end of the cup-shaped element is furnished with a nozzle, the nozzle having thereinside a third channel extending to both opposite ends of the nozzle to form a third inlet end and a third outlet end, respectively, the tapered channel, and the second channel and the third channel are co-axially connected; wherein a process aerosol enters the third channel from the tapered area via the third inlet end, and then is sprayed out through the third outlet end; wherein, when the adjustment element is displaced in parallel to the axis, a width of the tapered annular gap is varied as well, and thus a flow rate and a flow velocity of the process gas and an amount of the process aerosol sprayed out from the nozzle are varied accordingly.

17. The annular airflow regulating method of claim 12, wherein each of the plurality of second holes has a projection disposed within the annular plane.

18. The annular airflow regulating method of claim 12, wherein the tapered portion and the tapered channel have the same taper, and the width of the tapered annular gap is uniform.

19. The annular airflow regulating method of claim 12, wherein the ring-shaped groove has an annular wall, an angle is formed between the annular wall and the annular plane, and the angle is within 90°±5°.

20. The annular airflow regulating method of claim 19, wherein the annular plane is spaced to the gas-outlet end of any of the plurality of second holes by a distance L, a connecting portion of the annular wall and the annular plane has a radian R, and R=L/2.
